(19) United States
(12) Patent Application Publication
(10) Pub. No.: US 2008/0127736 A1
(43) Pub. Date: Jun. 5, 2008

(54) Sonar and Ultrasound Emitter that Generates Shock Wave Vibratory Forces by the Crack-the-Whip Motion of Materials for Testing and Measuring and Imaging Purposes

(76) Inventor: Stephen Bruce Berman, Austin, TX (US)

Correspondence Address: Stephen Bruce Berman, 1406 Miami Drive, Austin, TX, 78733-1940, US

(21) Appl. No.: 11/941,077

(22) Filed: Nov. 16, 2007

Related U.S. Application Data
(60) Provisional application No. 60/866,601, filed on Nov. 20, 2006.

(51) Int. Cl. G01M 7/00

(52) U.S. Cl. 73/662

(57) ABSTRACT

Ultrasound and sonar emitters that generate shock waves are disclosed. Shock wave vibrations are generated by the crack-the-whip motion of materials. Shock wave ultrasound or shock wave sonar can be used for such as medical ultrasound imaging; security and package inspection; petroleum, mineral, subsurface and underwater exploration; quality control, non-destructive testing, and flaw detection; nautical and fresh water sonar depth sounding, fish locating and underwater bottom profiling.

### CROSS-REFERENCED APPLICATIONS

This application for a utility patent is based upon the provisional patent application #60866601 filed on 20 Nov. 2006.

### STATEMENT OF FEDERALLY SPONSORED RESEARCH AND DEVELOPMENT

None

### REFERENCE TO SEQUENCE LISTING

Not Applicable

### BACKGROUND OF INVENTION

1. Technical Field

This invention generally relates to measuring and testing and pertains to methods and apparatus for making a measurement of any kind or for making a test of any kind. The terms testing or measurement include, but are not limited to, inspection, determining qualities, sensing, or imaging.

Further, this invention generally relates to methods and apparatus for producing vibrator devices for testing or measuring of an article or mechanism, hereinafter known as a body or a test body.

Further, this invention generally relates to vibrator devices for testing or measuring a body or a test body by reception, transduction and analysis of vibratory forces transmitted, refracted or reflected by the body or test body, of the vibratory forces generated by the vibratory device.

Further, this invention generally relates to vibrator devices that generate shock wave vibratory forces which are applied to bodies or test bodies for measuring purposes or testing purposes.

2. Background Art

The background art of the present invention includes methods and apparatus useful for application of vibratory forces to bodies or test bodies to determine, for example, qualities, characteristics, conditions, or, for example, to perform examination, inspection, material characterization, sensing and imaging of internal and external structures.

Methods and apparatus have been developed to produce vibrator devices constructed and adapted for producing and applying vibratory forces to one or more bodies or test bodies.

Methods and apparatus have also been developed for housing the vibrator devices.

Methods and apparatus have also been developed for coupling the vibrator devices to the one or more bodies or test bodies.

Methods and apparatus have also been developed for positioning the vibrator devices in relation to the one or more bodies or test bodies.

Methods and apparatus have also been developed for focusing the generated vibratory forces before application to one or more bodies or test bodies.

Methods and apparatus have also been developed for focusing vibratory forces transmitted, refracted and reflected after application of generated vibratory forces to the one or more bodies or test bodies.

Methods and apparatus have also been developed for temporally controlling the vibrator devices, for displaying information about the temporal control of the vibrator devices, and for recording information about the temporal control of the vibrator devices.

Methods and apparatus have also been developed for analyzing information about the temporal control of the vibrator devices, for displaying the analyzed temporal control information, and for recording the analyzed temporal control information.

Methods and apparatus have also been developed for spatially controlling the vibrator devices, for displaying information about the spatial control of the vibrator devices, and for recording the information about the spatial control of the vibrator devices.

Methods and apparatus have also been developed for analyzing information about the spatial control of the vibrator devices, for displaying the analyzed spatial control information, and for recording the analyzed spatial control information.

Methods and apparatus have also been developed for receiving and transducing vibratory forces propagated by any transmission through, reflection from, or refraction by one or more bodies or test bodies after application of generated vibratory forces to the one or more bodies or test bodies.

Methods and apparatus have also been developed for displaying the received and transduced vibratory forces and for recording the received and transduced vibratory forces.

Methods and apparatus have also been developed for analysis of the received and transduced vibratory forces and for display of the analysis of the received and transduced vibratory forces and for recording of the analysis of the received and transduced vibratory forces.

Methods and apparatus particularly adapted for producing and applying vibratory forces to one or more bodies or test bodies for test purposes or measurement purposes have applied vibratory forces, such as sine waves, that are not shock waves or generated from shock waves.

Methods and apparatus particularly adapted for producing and applying vibratory forces to one or more bodies for test purposes or measurement purposes have applied vibratory forces that are shock waves, such as disclosed in U.S. Pat. Nos. 5,665,917, 6,460,415, and 6,799,465, all by Berman. Shock wave vibratory systems and shock wave vibrators that generate shock wave vibratory forces that are applied to bodies or test bodies may improve upon or give alternate means for measuring and testing of bodies or test bodies relative to vibratory systems that generate and apply sine wave vibratory forces. The U.S. Pat. Nos. 5,665,917 and 6,460,415 include methods and apparatus that generate shock wave vibratory forces by collapsing cavitations within fluids. The U.S. Pat. No. 6,799,465 includes methods and apparatus that generate shock waves by the severing or clipping of

wires.

Also disclosed and claimed were methods and apparatus for housing the vibrator devices.

Also disclosed and claimed were methods and apparatus for coupling the vibrator devices to the one or more bodies or test bodies.

Also disclosed and claimed were methods and apparatus for positioning the vibrator devices in relation to the one or more bodies or test bodies.

Also disclosed and claimed were methods and apparatus for focusing the generated shock wave vibratory forces before application to one or more bodies or test bodies.

Also disclosed and claimed were methods and apparatus for temporally controlling the vibrator devices and for displaying information about the temporal control of the vibrator devices and for recording information about the temporal control of the vibrator devices.

Also disclosed and claimed were methods and apparatus for analyzing information about the temporal control of the vibrator devices and for displaying the analyzed temporal control information and for recording the analyzed temporal control information.

Also disclosed and claimed were methods and apparatus for spatially controlling the vibrator devices and for displaying information about the spatial control of the vibrator devices and for recording information about the spatial control of the vibrator devices.

Also disclosed and claimed were methods and apparatus for analyzing information about the spatial control of the vibrator devices and for displaying the analyzed spatial control information and for recording the analyzed spatial control information.

Also disclosed and claimed were methods and apparatus for focusing, receiving and transducing vibratory forces propagated by any transmission through, reflection from, or refraction by one or more bodies or test bodies after application of generated shock wave vibratory forces to the one or more bodies or test bodies.

Also disclosed and claimed were methods and apparatus for displaying the received and transduced vibratory forces and for recording the received and transduced vibratory forces.

Also disclosed and claimed were methods and apparatus for analyzing the received and transduced vibratory forces and for display of the analysis the received and transduced vibratory forces and for recording of the analysis of the received and transduced vibratory forces.

### BRIEF SUMMARY OF INVENTION

A brief summary of the present invention is that it reveals methods of and apparatus for producing vibrator devices that generate one or more shock wave vibratory forces by one or more distal ends of one or more materials changing direction by whipping from the proximal end.

The generated shock wave vibratory forces are applied to one or more bodies or test bodies for such useful purposes as measuring, testing, or sensing or imaging.

Also disclosed and claimed are methods and apparatus to house the vibrator devices.

Also disclosed and claimed are methods and apparatus to couple the vibrator devices to the one or more bodies or test bodies.

Also disclosed and claimed are methods and apparatus to position the vibrator devices in relation to the one or more bodies or test bodies.

Also disclosed and claimed are methods and apparatus to focus the generated shock wave vibratory forces before application to one or more bodies or test bodies.

Also disclosed and claimed are methods and apparatus to temporally control the vibrator devices and to display information about the temporal control of the vibrator devices and to record the information about the temporal control.

Also disclosed and claimed are methods and apparatus to analyze information about the temporal control of the vibrator devices and to display the analyzed temporal control information and to record the analyzed temporal control information.

Also disclosed and claimed are methods and apparatus to spatially control the vibrator devices and to display information about the spatial control of the vibrator devices and to record the information about the spatial control.

Also disclosed and claimed are methods and apparatus to analyze information about the spatial control of the vibrator devices and to display the analyzed spatial control information and to record the analyzed spatial control information.

Also disclosed and claimed are methods and apparatus to focus vibratory forces propagated by any transmission through, reflection from, or refraction by one or more bodies or test bodies, of the generated and applied shock wave vibratory forces.

Also disclosed and claimed are methods and apparatus to receive and to transduce vibratory forces propagated by any transmission through, reflection from, or refraction by one or more bodies or test bodies, of the generated and applied shock wave vibratory forces.

Also disclosed and claimed are methods and apparatus to display the received and transduced vibratory forces and to record the received and transduced vibratory forces.

Also disclosed and claimed are methods and apparatus to analyze the received and transduced vibratory forces and to display the analysis of the received and transduced vibratory forces and to record of the analysis of the received and transduced vibratory forces.

Also disclosed and claimed are methods and apparatus to position or to support or to feed or to remove the one or more materials whose one or more distal ends change direction by whipping from the proximal end causing generation of the shock wave vibratory forces.

Also disclosed and claimed are methods and apparatus to melt or to vaporize the one or more materials whose one or more distal ends change direction by whipping from the proximal end causing generation of the shock wave vibratory forces prior to disposal or recycling by reforming into the one or more materials whose one or more distal ends change direction by whipping from the proximal end causing generation of the shock wave vibratory forces.

Also disclosed and claimed are methods and apparatus to dispose or to recycle by reforming of the one or more materials whose one or more distal ends change direction by whipping from the proximal end causing generation of the shock wave vibratory forces.

### BRIEF DESCRIPTION OF VIEWS OF THE DRAWING

A brief description of the views of the drawing follows.

FIG. 1 shows a vibrator device that generates one or more shock wave vibratory forces including a whipping from the proximal end of one or more materials device that changes the direction of the distal end of the one or more materials, such as a leather strand with a cracker (101), a whipping leather strand with a cracker is shown in the drawing in two positions, each moving in opposite directions, as indicated by the double-pointed arrow, one position indicated by solid line and the other position indicated by dotted lines, activated by motor (100), and a test body (110) to which the generated one or more shock wave vibratory forces are applied for measuring and testing purposes.

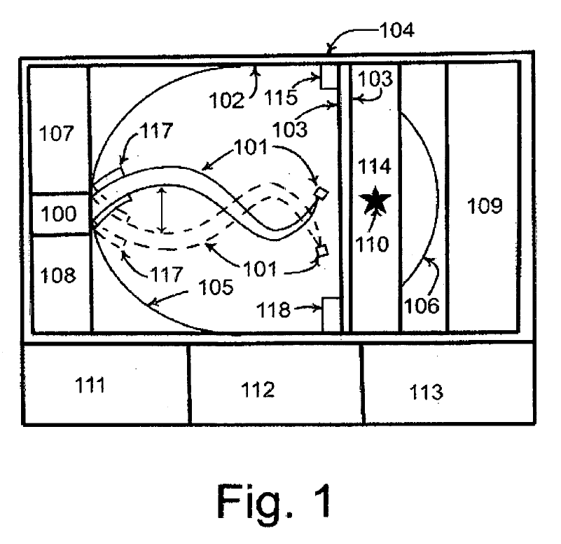

Also included are means for housing of the vibrator device (102), and for spatial controlling of the vibrator device (107), and for temporal controlling of the vibrator device (108), and for positioning the spatial relationship between the vibrator device and the body or test body (114), and for focusing shock wave vibratory forces generated by the vibrator device before applying the shock wave vibratory forces generated by the vibrator device to a body or test body (105), and for coupling shock wave vibratory forces generated by the vibrator device to a body or test body (103), and for focusing vibratory forces transmitted, refracted or reflected after applying the shock wave vibratory forces generated by the vibrator device to a body or test body (106), and for receiving and transducing vibratory forces transmitted, refracted or reflected after applying the shock wave vibratory forces generated by the vibrator device to a body or test body (109), and for analyzing information about the vibrator device and the shock wave vibratory forces generated and applied by the vibrator and vibratory forces transmitted, refracted and reflected after applying the generated shock wave vibratory forces to the body or test body (111), and for recording information about the vibrator device and the shock wave vibratory forces generated and applied by the vibrator and vibratory forces transmitted, refracted and reflected after application to the body or test body (112), and for displaying information about the vibrator device and the shock wave vibratory forces generated and applied by the vibrator and vibratory forces transmitted, refracted and reflected after application to the body or test body (113), and for electromagnetic interconnections, mechanical interconnections, or interconnections by other methods and apparatuses for communication between the means (104), and for positioning or supporting or feeding or removing the one or more materials whose distal end changes direction by whipping from the proximal end to generate the shock wave vibratory forces (117), and for melting or vaporizing the one or more materials whose distal end changes direction by whipping from the proximal end causing generation of the shock wave vibratory forces prior to disposal or recycling by reforming into the one or more materials whose distal end changes direction by whipping from the proximal end causing generation of the shock wave vibratory forces (115), and for disposing or recycling by reforming of the one or more materials whose the distal end changes direction by whipping from the proximal end causing generation of the shock wave vibratory forces (118).

### DETAILED DESCRIPTION OF THE INVENTION

A detailed description of a single preferred embodiment of the present invention is that of one or more shock wave vibratory forces are generated by the change of direction by whipping from the proximal end of one or more distal ends of one or more materials, such as a leather strand with a cracker (101).

The one or more shock wave vibratory forces generated when one or more distal ends of one or more materials are caused to change direction by whipping from the proximal end are then applied to one or more bodies or test bodies (110) for measuring or testing purposes or imaging purposes.

The methods and apparatuses used in the production of the one or more materials whose one or more distal ends change direction by whipping from the proximal end to generate the one or more shock wave vibratory forces (101) are those known to those versed in the art.

The methods and apparatuses used to change direction of the one or more distal ends of one or more solid materials by whipping from the proximal end to generate the one or more shock wave vibratory forces, such as a motor (100) are those known to those versed in the art.

The methods and apparatus used to house the vibrator device (102) are those known to those versed in the art.

The methods and apparatus used to couple the shock wave vibratory forces generated and applied by the vibrator device to the one or more bodies or test bodies (103) are those known to those versed in the art.

The methods and apparatus used to position the vibrator device in relation to the one or more bodies or test bodies (114) are those known to those versed in the art.

The methods and apparatus used to focus the generated shock wave vibratory forces before applying the generated shock wave vibratory forces to one or more bodies or test bodies (105) are those known to those versed in the art.

The methods and apparatus used to focus the vibratory forces transmitted, refracted and reflected after applying the generated shock wave vibratory forces to one or more bodies or test bodies (106) are those known to those versed in the art.

The methods and apparatus used to temporally control the vibrator device (108) and to display and information about the temporal control of the vibrator device (113) and to record the temporal control information (112) are those known to those versed in the art.

The methods and apparatus used to analyze information about the temporal control of the vibrator device (111) and to display the analyzed temporal control information (113) and to record the analyzed temporal control information (112) are those known to those versed in the art.

The methods and apparatus used to spatially control the vibrator device (107) and to display information about the spatial control of the vibrator device (113) and to record the spatial control information (112) are those known to those versed in the art.

The methods and apparatus used to analyze information about the spatial control of the vibrator device (111) and to display the analyzed spatial control information (113) and to record the analyzed spatial control information (112) are those known to those versed in the art.

The methods and apparatus used to receive and transduce vibratory forces propagated by any transmission through, reflection from, or refraction by one or more bodies or test bodies of the generated and applied shock wave vibratory forces (109) are those known to those versed in the art.

The methods and apparatus used to display the received and transduced vibratory forces propagated by any transmission through, reflection from, or refraction by one or more bodies or test bodies of the generated and applied shock wave vibratory forces (113) and to record the received and transduced vibratory forces propagated by any transmission through, reflection from, or refraction by one or more bodies or test bodies of the generated and applied shock wave vibratory forces (112) are those known to those versed in the art.

The methods and apparatus to used analyze the received and transduced vibratory forces propagated by any transmission through, reflection from, or refraction by one or more bodies or test bodies of the generated and applied shock wave vibratory forces (111) and to display the analysis of the received and transduced vibratory forces propagated by any transmission through, reflection from, or refraction by one or more bodies or test bodies of the generated and applied shock wave vibratory forces (113) and to record of the analysis of the received and transduced vibratory forces propagated by any transmission through, reflection from, or refraction by one or more bodies or test bodies of the generated and applied shock wave vibratory forces (112) are those known to those versed in the art.

The methods and apparatus used to provide communication between the component means of the vibrator device by electromagnetic interconnections, mechanical interconnections, or interconnections by other methods and apparatus (104) are those known to those versed in the art.

The methods and apparatus used to position or to support or to feed or to remove (117) the one or more materials whose one or more distal ends change direction by whipping from the proximal end causing generation of the shock wave vibratory forces are those known to those versed in the art.

The methods and apparatus used to melt or to vaporize (115) the one or more materials whose one or more distal ends change direction by whipping from the proximal end causing generation of the shock wave vibratory forces prior to disposal or recycling by reforming into the one or more materials whose one or more distal ends change direction by whipping from the proximal end causing generation of the shock wave vibratory forces are those known to those versed in the art.

The methods and apparatus used to dispose or to recycle by reforming (118) into the one or more materials whose one or more distal ends change direction by whipping from the proximal end causing generation of the shock wave vibratory forces are those known to those versed in the art.

While the invention has been described with respect to a single embodiment and variations set forth above, this embodiment and variations are illustrative and the invention is not to be considered limited in scope to this embodiment and variations. For example, the geometries of housing may be altered to accommodate, for example, different bodies or test bodies to be measured or tested, different operating environments, optimization of shock wave generation and optimization of shock wave application. Accordingly, various other embodiments, variations, modifications and improvements not described herein may be within the spirit and scope of the present invention, as defined by the following claims.

What I claim is:

1) The method of producing vibrator devices by one or more distal ends of one or more materials changing direction by whipping from the proximal end causing generation of one or more shock wave vibratory forces and applying the one or more shock wave vibratory forces generated to one or more bodies or test bodies to measure or to test the one or more bodies or test bodies.

2) This vibrator device of claim 1 is further improved by methods to house the vibrator device.

3) This vibrator device of claim 1 is further improved by methods to couple shock wave vibratory forces generated by the vibrator device for application to the one or more bodies or test bodies and analyze, display, record or output information about the coupling of the vibrator device to the one or more bodies or test bodies.

4) This vibrator device of claim 1 is further improved by methods to spatially control the vibrator device in relation to the one or more bodies or test bodies and analyze, display, record or output information about the spatial control of the vibrator device.

5) This vibrator device of claim 1 is further improved by methods to temporally control the vibrator device and to analyze, display, record or output information about the temporal control of the vibrator device.

6) This vibrator device of claim 1 is further improved by methods to focus the produced shock wave vibratory forces before application to one or more bodies or test bodies or to focus the produced vibratory forces after any transmission through, reflection from, or refraction by one or more bodies or test bodies and to analyze, display, record or output information about the focusing.

7) This vibrator device of claim 1 is further improved by methods to receive and transduce vibratory forces propagated by any transmission through, reflection from, or refraction by one or more bodies or test bodies of the generated and applied shock wave vibratory forces, and to analyze, display, record, or output the received and transduced vibratory forces propagated by any transmission through, reflection from, or refraction by one or more bodies or test bodies of the generated and applied shock wave vibratory forces.

8) This vibrator device of claim 1 is further improved by methods to position or to support or to feed or to remove the one or more materials whose one or more distal ends change direction by whipping from the proximal end causing generation of the shock wave vibratory forces.

9) This vibrator device of claim 1 is further improved by methods to melt or to vaporize the one or more materials whose one or more distal ends change direction by whipping from the proximal end causing generation of the shock wave vibratory forces prior to disposal or recycling by reforming into the one or more materials whose one or more distal ends change direction by whipping from the proximal end causing generation of the shock wave vibratory forces.

10) This vibrator device of claim 1 is further improved by methods to dispose of or to recycle by reforming into the one or more materials whose one or more distal ends change direction by whipping from the proximal end causing generation of the shock wave vibratory forces.

11) An apparatus comprising one or more vibrator devices that change direction by whipping from the proximal end of one or more distal ends of one or more materials causing generation of one or more shock wave vibratory forces and applying the shock wave vibratory forces generated to one or more bodies or test bodies to measure or to test the one or more bodies or test bodies.

12) This apparatus of claim 11 is further improved by apparatus that house the vibrator device.

13) This apparatus of claim 11 is further improved by apparatus that couple the shock wave vibratory forces generated by the vibrator device for application to the one or more bodies or test bodies and that analyze, display, record or output information about the coupling of the vibrator device to the one or more bodies or test bodies.

14) This apparatus of claim 11 is further improved by apparatus that spatially control the vibrator device and that analyze, display, record or output information about the temporal control of the vibrator device.

15) This apparatus of claim 11 is further improved by apparatus that temporally control the vibrator devices and that analyze, display, record or output information about the temporal control of the vibrator device.

16) This apparatus of claim 11 is further improved by apparatus that focus the produced one or more shock wave vibratory forces before application to one or more bodies or test bodies or that focus the produced one or more shock wave vibratory forces after any transmission through, reflection from, or refraction by one or more bodies or test bodies and that analyze, display, record or output information about the focusing.

17) This apparatus of claim 11 is further improved by apparatus that receive and transduce the one or more shock wave vibratory forces propagated by any transmission through, reflection from, or refraction by one or more bodies or test bodies and that analyze, display, record, or output the received and transduced one or more one or more shock wave vibratory forces propagated by any transmission through, reflection from, or refraction by one or more bodies or test bodies.

18) This apparatus of claim 11 is further improved by apparatus that position or that support or that feed or that remove the one or more materials whose one or more distal ends change direction by whipping from the proximal end causing generation of the shock wave vibratory forces.

19) This apparatus of claim 11 is further improved by apparatus that melt or that vaporize the one or more materials whose one or more distal ends change direction by whipping from the proximal end causing generation of the shock wave vibratory forces for disposal of or recycling by reforming into the one or more materials whose one or more distal ends change direction by whipping from the proximal end causing generation of the shock wave vibratory forces.

20) This apparatus of claim 11 is further improved by apparatus that dispose of or recycling by reforming into the one or more materials whose one or more distal ends change direction by whipping from the proximal end causing generation of the shock wave vibratory forces.
